(19) United States
(12) Patent Application Publication
(10) Pub. No.: US 2007/0164127 A1
(43) Pub. Date: Jul. 19, 2007

(54) Firefighting fluid delivery system

(76) Inventors: Todd Brian Lozier, Elkhart, IN (US); Lee R. Jones, Wakarusa, IN (US)

Correspondence Address: VAN DYKE, GARDNER, LINN AND BURKHART, LLP, SUITE 207, 2851 CHARLEVOIX DRIVE, S.E., GRAND RAPIDS, MI, 49546, US

(21) Appl. No.: 11/636,138

(22) Filed: Dec. 8, 2006

Related U.S. Application Data
(60) Provisional application No. 60/748,557, filed on Dec. 8, 2005.

(51) Int. Cl. A62C 31/00; A62C 27/00; A62C 37/08; F17D 3/01

(52) U.S. Cl. 239/71; 169/5; 239/722; 137/351; 137/557; 222/23; 137/552; 222/25; 222/57

(57) ABSTRACT

A fire fighting fluid delivery system includes a fire fighting fluid delivery device, a pressure sensor, which senses fluid pressure at the fluid delivery device and generates a pressure signal indicative of the fluid pressure, and a wireless transmitter for transmitting the pressure signal. The fluid delivery system further includes a fire fighting fluid input device which is in fluid communication with the fluid delivery device and a wireless receiver that receives the pressure signal. In addition, the system includes a pressure gauge in communication with the receiver, which displays a pressure reading based on the pressure signal received by the receiver wherein a pump operator may selectively adjust the delivery of fluid to the fluid delivery device from the fluid input device based on the pressure reading displayed at the pressure gauge.

The present application claims the benefit of U.S. provisional application Ser. No. 60/748,557 for FIRE FIGHTING FLUID DELIVERY SYSTEM, filed on Dec. 8, 2005, which is incorporated by reference herein in its entirety.

### TECHNICAL FIELD AND BACKGROUND OF THE INVENTION

The present invention generally relates to a fire fighting fluid delivery system and, more particularly, to a control system for controlling the flow of fire fighting fluid from a fluid delivery device of a fire fighting fluid delivery system, such as a nozzle, monitor, fire truck outlet or the like.

Successful fire fighting is dependent on the adequate application of water to a fire. Many factors effect adequate water application—two specifically important aspects are technique and quantity of water. All fire fighting products depend on the direct correlation of water pressure and flow orifice at the delivery device (nozzle, monitor, etc) to determine the flow rate of water delivered. One of the most critical systematic parameters a firefighter must control is inlet pressure at the water delivery device. Typically, pump operators set engine pressures at levels which will account for pressure loss through the in-line delivery devices (hose, wyes, valves, elevation conditions, monitors, etc) such that the desired pressure is achieved at the nozzle. This tends to be an educated guess coordinated by pre-fire training, trial and pressure charting, heat of the battle feel, and verbal radio communication of firefighters. Consequently, optimal flow conditions may not be achieved at all times.

Accordingly, there is a need for a fire fighting fluid delivery system that can provide greater accuracy over the control of the delivery of the fire fighting fluid, which would provide enhanced safety to firefighters and allow the firefighters to operate their fire fighting equipment with optimal flow conditions at most, if not, all times.

### SUMMARY OF THE INVENTION

Accordingly, the present invention provides a fire fighting fluid delivery system that provides better control over the pressure of the fire fighting fluid delivered by the system and, further, may provide enhanced information relating to the fire fighting fluid, such as the flow rate, temperature, or the like.

In one form of the invention, a fire fighting fluid delivery system includes a fire fighting fluid delivery device, a pressure sensor, a wireless transmitter, a fire fighting input device, a wireless receiver, and a pressure gauge. The pressure sensor senses fluid pressure at the fluid delivery device and generates a pressure signal indicative of the fluid pressure, which is transmitted by the transmitter and received by the receiver, which is in communication with the pressure gauge. The pressure gauge displays a pressure reading based on the pressure signal wherein a pump operator may selectively adjust the delivery of fluid to the fluid delivery device from the input device based on the pressure reading displayed at the pressure gauge.

In one aspect, the fluid delivery device comprises a nozzle, a monitor, including a fixed or portable monitor, a truck outlet, a pipe, for example in a standpipe water system that delivers fire fighting fluid, typically water, to the various floors in a building, or a valve. For example, the nozzle may be mounted to the end of a fire hose, including a fire hose connected to a truck, to a valve on a standpipe, or to a monitor, such as a fixed monitor, including an aerial monitor mounted on an aerial truck, or a portable monitor. In a further aspect, the fluid input device comprises a pump.

In other aspects, the sensor comprises a pressure transducer, such as an electronic pressure transducer. Further, the system includes a voltage supply at the fluid delivery device, which powers the electronic pressure transducer.

In another aspect, the wireless transmitter comprises an RF transmitter, and the receiver comprises an RF receiver.

In yet other aspects, the fluid delivery device comprises a first fluid delivery device, and the fluid delivery system further includes a second fluid delivery device. The second fluid delivery device includes a second sensor that senses a parameter at the second fluid delivery device and is in communication with the transmitter for communicating the parameter to the receiver. For example, the system may include a second pressure gauge. The second gauge may display for example a pressure reading based on the pressure measured by the second sensor wherein a pump operator may adjust the delivery of fire fighting fluid to the second fluid delivery device based on the pressure reading displayed by the second pressure gauge.

According to yet another aspect, the system further includes a second gauge and a second sensor measuring a parameter of the fire fighting fluid at the fire fighting fluid delivery device and generating a parameter signal. The second sensor may be a flow sensor, an RPM sensor, or a temperature sensor and is in communication with the second gauge, which displays a reading of the parameter based on the parameter signal.

According to another form of the invention, a fluid delivery system includes a fire fighting fluid delivery device, a pressure sensor, a wireless transmitter, a fire fighting fluid communication with the fluid delivery device, and a controller. The pressure sensor senses fluid at the fluid delivery device and generates a pressure signal. The controller is in communication with the transmitter and the input device and selectively actuates the fluid input device to deliver fluid to the fluid delivery device and adjusts the delivery of fluid from the fluid input device to the fluid delivery device in response to the pressure signal from the transmitter.

For example, the fluid delivery device may comprise a nozzle, a monitor, a truck outlet, a pipe, or a valve. The fluid input device may comprise a pump.

In one aspect, the sensor comprises a pressure transducer, such as an electronic pressure transducer.

In yet another aspect, a second fluid delivery device and a second pressure sensor sensing fluid pressure at the second fluid delivery device are provided. The second sensor generates a second pressure signal and is in communication with the controller, which adjusts the delivery of fire fighting fluid to the second fluid delivery device based on the second pressure signal. For example, the second pressure sensor senses fluid pressure at an input of the second fluid delivery device.

In yet another form of the invention, a fire truck fluid delivery system includes a fluid delivery device for delivering fluid, a sensor, a wireless transmitter in communication with the sensor, and a control panel. The sensor senses a parameter of the fluid at the fluid delivery device and generates a parameter signal, which is transmitted by the transmitter. The control panel includes a gauge and a receiver, which receives the parameter signal from the transmitter and is in communication with the gauge. The gauge displays a parameter reading based on the parameter signal.

In one aspect, the fluid delivery device comprises a first fluid delivery device. The system further includes a second fluid delivery device and a second sensor sensing a parameter of the fluid at the second fluid delivery device. The control panel has a second gauge, which displays the parameter of the fluid at the second fluid delivery device in response to the second sensor sensing the parameter. For example, the second sensor may sense fluid pressure at the second fluid delivery device.

Accordingly, the present invention provides a system that provides enhanced control over the delivery of the fire fighting fluid by providing actual pressure readings of the fluid at the delivery devices, which results in a greater control over the flow of the fire fighting fluid being delivered by the system.

These and other objects, advantages, purposes, and features of the invention will become more apparent from the study of the following description taken in conjunction with the drawings.

### DETAILED DESCRIPTION OF THE DRAWINGS

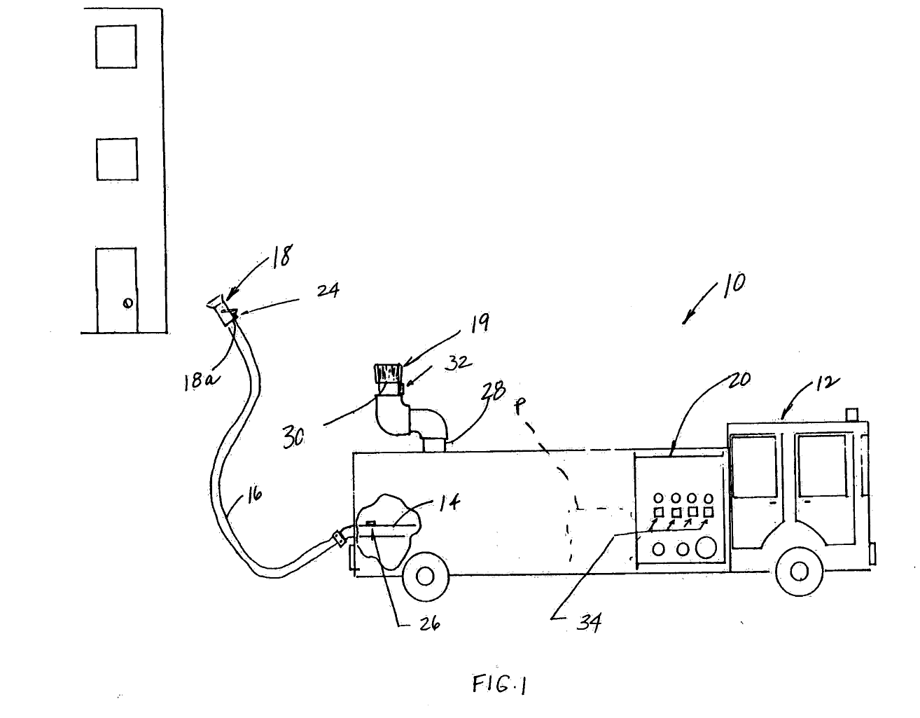

FIG. 1 is a schematic view of a fire fighting fluid delivery system of the present invention;

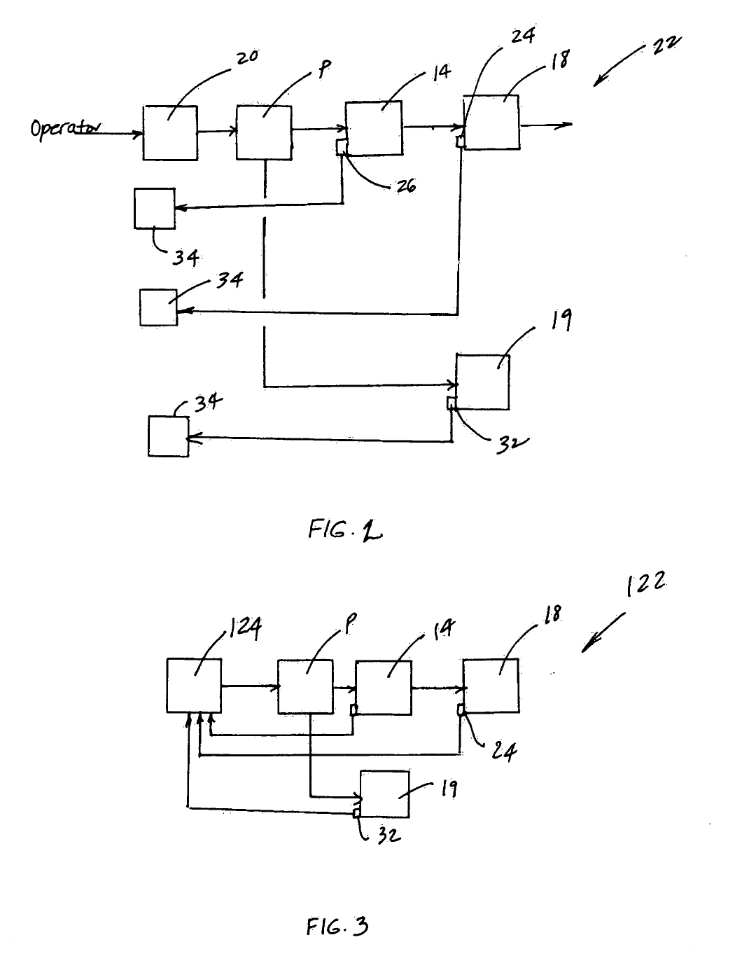

FIG. 2 is a schematic drawing of the control system of the fire fighting fluid delivery system of FIG. 1; and

FIG. 3 is a schematic drawing of another embodiment of the control system.

### DETAILED DESCRIPTION OF THE PREFERRED EMBODIMENTS

Referring to FIG. 1, the numeral 10 generally designates a fire fighting fluid system of the present invention. As will be more fully described below, system 10 provides enhanced control over of the delivery of fire fighting fluid and allows for one or more parameters of the fluid to be monitored, such as pressure, flow rate, temperature, or the like, as well as parameters of the system components, such as a fire truck's engine speed (RPM) to thereby provide enhanced management of the fire fighting fluid. Control is achieved by using a feedback control loop that allows one or more fluid parameters to be monitored at one or more specific points of interest, such as at a fire fighting delivery device, such as a nozzle, especially a nozzle inlet, a monitor, a truck outlet connection, a pipe, or a valve, for example.

In the illustrated embodiment, system 10 is incorporated in a fire truck 12, which includes a fire truck outlet 14, which is in fluid communication with the truck fire fighting fluid storage tank or external water supply through the truck pump P, and a fire hose 16, which connects to outlet 14. In addition, truck 12 includes a monitor 19, which is in fluid communication with the truck tank, also through pump P. Further, truck 12 includes a control panel 20, which includes various gauges and controls for controlling the operation of the truck pump P, which pumps the fire fighting fluid, namely water, from the truck's storage tank or tanks. Truck 12 may be any type of fire truck, including an aerial truck with the monitor mounted to the ladder or other extendable structure.

In contrast to conventional fire trucks where the pump is operated by a pump operator in response to visual or verbal commands from the firefighter holding nozzle 18 or operating the monitor, system 10 includes a control system 22 (see FIG. 2), which provides actual pressure readings at a fire fighting fluid delivery device, such as at nozzle 18, monitor 19, and/or truck outlet 14 to enable the pump operator to operate pump P in a manner to achieve greater control over the fire fighting fluid pressure at the various fire fighting fluid delivery devices, such as nozzle 18, outlet 14, and/or monitor 19. In this manner, greater control can be achieved over the flow rate of the fire fighting fluid through the various fire fighting fluid delivery devices. While the present invention is discussed in reference to a fire truck, as noted the present invention may also be used in a standpipe water system where the fire fighting fluid is delivered through the standpipe to the various floors of a building. Typically, each floor will have a pressure reducing valve to control the pressure of the water delivered to the hose connection at that floor. Therefore, the present invention may be used to monitor the pressure at the pressure reducing valve, for example at the outlet or connection to the hose or in the piping connected to the valve to monitor the pressure at one or more of these points of interest.

For ease of description, reference hereinafter will be made to the application to a fire truck. Referring again to FIG. 1, system 10 includes a pressure sensor 24 at nozzle 18, which detects the pressure of the fire fighting fluid, for example at nozzle inlet 18a. In order to mount the sensor, nozzle 18 may include a threaded hole through to the water way. The sensor may then be threaded into the hole (or at least the sensing portion of the sensor) so that the pressure of the fluid in the nozzle can be sensed. Control panel 20 includes a pressure gauge 34, which is in communication with sensor 24 and displays the actual pressure of the fire fighting fluid at inlet 18a of nozzle 18 as measured by sensor 24 so that the pump operator may adjust the pump rate of pump P to either increase or decrease the pressure as needed to achieve the desired pressure at nozzle inlet 18a, which increase or decrease can be confirmed by the operator viewing pressure gauge 34. Sensor 24 may comprise a pressure transducer, such as an electronic pressure transducer, and generates signals that are proportional to the magnitude of the pressure of the fire fighting fluid at nozzle 18 and, more specifically, at inlet 18a of nozzle 18. Further, sensor 24 may include a voltage supply so that sensor 24 is a self-contained unit. For example, the voltage supply may comprise a rechargeable voltage supply, such as a rechargeable battery. Further, sensor 24 is in communication with or includes a wireless transmitter, such as an RF transmitter, which transmits the signals that are generated by sensor 24 to control panel 20. The sensor's voltage supply and transmitter may all be coupled to or mounted on a circuit board with the appropriate logic devices and circuitry to power the sensor and further process the signals from the sensor. In addition, as will be more fully described below, the circuit board may have appropriate logic devices and circuitry for powering indicators that may also be mounted at the nozzle.

Control panel 20 includes a wireless receiver, such as an RF receiver, which receives the pressure signals from the transmitter (and sensor 24) and adjusts pressure gauge 34 on panel 20 to display the actual pressure at the nozzle inlet 18a. As would be understood by those skilled in the art, this information is then used by the pump operator to adjust the output of the pump.

Referring again to FIG. 1, optionally, truck outlet 14 may also, or alternatively, include a sensor 26, which monitors the pressure of the fire fighting fluid at truck outlet 14. Similarly, sensor 26 is in communication with or includes a wireless transmitter, such as an RF transmitter, that is in communication with another receiver at pump panel 20. Sensor 26 similarly generates pressure signals proportional to the magnitude of the fluid at outlet 14, which are received by the other receiver at panel 20 for display at a second pressure gauge 34 at panel 20. Again, this information may then be used by a pump operator to adjust the output pressure of the pump to meet a desired pressure at truck outlet 14. Alternately, sensor 26 may send signals to control panel 20 through another transmission medium, such as a wiring or cable, including an optical cable. Though in preferred form, the transmitter is wireless and the transmission medium is air.

Truck 12 may also include a second outlet 28 for mounting monitor 19 to truck 12 and for delivering fire fighting fluid to monitor 19, which may also include a sensor 32 that is in communication with panel 20 and which measures the pressure at monitor 19 and generates pressure signals, which are similarly transmitted to and received by panel 20. Again, in preferred form sensor 32 generates pressure signals that are transmitted by a wireless transmitter and received by a wireless receiver on panel 20. The pressure at monitor 19 is then displayed by a third pressure gauge 34 at panel 20. For example, the sensor may be mounted at the inlet or outlet of monitor 19 or at the inlet of the nozzle mounted to the monitor.

Although multiple receivers are described, a single receiver may be used to receive signals from all three sensors in combination with a controller, which evaluates each pressure signal and correlates each pressure signal with the appropriate pressure gauge.

Similar to sensor 24, sensors 26 and 32 are each preferably coupled to a voltage supply and preferably comprise self-contained units with the voltage supply incorporated into the sensor. For example, sensors 24, 26, and 32 may each include a battery, including a rechargeable battery. Because monitor 19 is mounted to truck 12, like sensor 26, sensor 32 may be hardwired into the truck battery power. Though it is preferable that the signals generated by sensor 32, especially when monitor 19 is mounted to a ladder on an aerial truck, are radio frequency signals to eliminate the need for hardwiring, which is particularly complicated on an extendable ladder or other extendable structure. Further, as noted, sensor 32 may include a voltage source, similar to sensor 24, so that monitor 19 may be used as a portable monitor.

In addition, indicators, such as LED indicators, may be incorporated to aid attack line fighters to indicate when the pressure at the delivery device is either below or above a desired setting or when the pressure is at the desired setting. For example, in reference to the nozzle, the indicator(s) may be mounted at the base of the nozzle, just forward of the nozzle inlet connection (which is generally either a fixed or swivel coupling). For example, the nozzle may be provided with a housing, such as a small box (for example ideally no more than 1″L×1.5″W×0.75″H in size) which contains the power supply (e.g. battery), the circuit board with the logic devices and circuitry, which direct power to the sensor, transmitter, and indicators. For example, the indicators may be powered based on the sensed pressure. As noted, the indicators may be mounted at the base of the nozzle just forward of the inlet connection. In this manner, the fire fighter's natural stance to hold the nozzle while in use will tend to provide line of sight visibility to the indicators. Normally, the hose goes under one arm or the other. The arm that the hose goes under is placed either on the pistol grip of the nozzle or behind the hose coupling for grip and does most of the work resisting the reaction force of the water stream. The off hand tends to hold the forward part of the nozzle and control direction and stream setting. This leaves the device strategically placed between the hands/arms of the fire fighter and easy to view at a quick glance downward.

It should be understood that the various sensors 24, 26, and 32 may be operated at the same time using generally known frequency hopping schemes to ensure signal individuality. Further, any one or more of the fire fighting delivery devices may include another sensor that measures another parameter of the fire fighting fluid, such as the flow rate, and/or temperature of the firefighting fluid and similarly provide feedback to the control panel, which may include a gauge for each of these parameters. In addition, truck 12 may include other sensors to monitor one or more of the truck's components, such as the engine, to monitor, for example, the engine speed (RPM).

Referring to FIG. 3, system 10 may alternately include a closed-loop feedback control system 122. Control system 122 similarly incorporates one or more of the sensors, such as pressure sensor 24 at nozzle 18, sensor 26 at outlet 14, and sensor 32 at monitor 19. Control system 122 may also include other sensors for measuring other fluid parameters similar to the previous embodiment. In contrast to the previous embodiment, control system 122 includes a controller 124 that is configured to control the pump. Controller 124 is in communication with the transmitters of the respective sensors via one or more receivers and is configured to control the operation of the pump in response to the signals received from the respective sensors to thereby maintain the pressure at a desired level at the respective fire fighting fluid delivery devices. For example, controller 124 may be configured to compare any one of the pressure sensor signals to a stored pressure setting for that particular fire fighting fluid delivery device and when the pressure signal falls below the stored pressure setting for that particular fire fighting fluid delivery device actuates or throttles the pump so that the pump output increases the pressure at the fire fighting fluid delivery device until the pressure at the fire fighting fluid delivery device reaches the desired pressure setting for that device. Similarly, sensors 24, 26, and 32 may be operated at the same time using generally known frequency hopping schemes.

Alternately, controller 124 may be configured to adjust the pressure only when the pressure signals fall above or below a range of acceptable pressure settings. In addition, system 122 may include alarms, which are actuated, for example, when the pressure at a given fire fighting fluid delivery device falls below a specified pressure setting. System 122 may also include gauges to display the pressure or other fluid parameter readings.

Consequently, it can be appreciated that the accuracy of the fluid pressure at the nozzle, monitor, or truck outlet may be greatly improved. Further, the firefighter may change hose lengths or add additional inline delivery devices, such as wyes or the like, with the pressure at the nozzle being adjusted by the pump operator or by the controller based on actual pressure readings rather than best estimates. While the present invention is described in reference to a nozzle on a hose, a monitor, and a truck outlet, it should be understood that the present invention has much broader application. As noted, the present invention can be used on a nozzle on a monitor, fixed or portable, or on a pipe or a hose of a standpipe water system where fire fighting fluid is delivered to the various floors in a building.

While several forms of the invention have been shown and described, other forms will now be apparent to those skilled in the art. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

The embodiments of the invention in which an exclusive property right or privilege is claimed are defined as follows:

1. A fire fighting fluid delivery system comprising:
a fire fighting fluid delivery device;
a pressure sensor, said pressure sensor sensing fluid pressure at said fluid delivery device and generating a pressure signal indicative of said fluid pressure;
a wireless transmitter transmitting said pressure signal;
a fire fighting fluid input device in fluid communication with said fluid delivery device;
a wireless receiver receiving said pressure signal; and
a pressure gauge in communication with said receiver, said pressure gauge displaying a pressure reading based on said pressure signal received by said receiver wherein a pump operator may selectively adjust the delivery of fluid to said fluid delivery device from said fluid input device based on said pressure reading displayed at said pressure gauge.

2. The fluid delivery system according to claim 1, wherein said fluid delivery device comprises a nozzle, a monitor, a truck outlet, a pipe, or a valve.

3. The fluid delivery system according to claim 1, wherein said fluid input device comprises a pump.

4. The fluid delivery system according to claim 1, wherein said sensor comprises a pressure transducer.

5. The fluid delivery system according to claim 4, wherein said transducer comprises an electronic pressure transducer.

6. The fluid delivery system according to claim 5, further comprising a voltage supply at said fluid delivery device, said voltage supply powering said electronic pressure transducer.

7. The fluid delivery system according to claim 1, wherein said wireless transmitter comprises an RF transmitter, and said receiver comprises an RF receiver.

8. The fluid delivery system according to claim 1, wherein said fluid delivery device comprises a first fluid delivery device, said fluid delivery system further comprising a second fluid delivery device, said second fluid delivery device including a second pressure sensor sensing a parameter at said second fluid delivery device and in communication with said transmitter.

9. The fluid delivery system according to claim 1, wherein said pressure sensor senses fluid pressure at an input of said fluid delivery device.

10. The fluid delivery system according to claim 1, further comprising a second gauge and a second sensor measuring a parameter of the fire fighting fluid at said fire fighting fluid delivery device and generating a parameter signal, said second sensor being selected from a flow sensor, an RPM sensor, and a temperature sensor and in communication with said second gauge, and said second gauge displaying a reading of said parameter based on said parameter signal.

11. A fluid delivery system comprising:
a fire fighting fluid delivery device;
a pressure sensor, said pressure sensor sensing fluid at said fluid delivery device and generating a pressure signal;
a wireless transmitter transmitting said pressure signal;
a fire fighting fluid input device for delivering fire fighting fluid to and in fluid communication with said fluid delivery device; and
a controller in communication with said wireless transmitter and said fluid input device, said controller selectively actuating said fluid input device to deliver fluid to said fluid delivery device and adjusting the delivery of fluid from said fluid input device to said fluid delivery device in response to said pressure signal from said transmitter.

12. The fluid delivery system according to claim 11, wherein said fluid delivery device comprises a nozzle, a monitor, a truck outlet, a pipe, or a valve.

13. The fluid delivery system according to claim 11, wherein said fluid input device comprises a pump.

14. The fluid delivery system according to claim 11, wherein said sensor comprises a pressure transducer.

15. The fluid delivery system according to claim 14, wherein said transducer comprises an electronic pressure transducer.

16. The fluid delivery system according to claim 15, further comprising a voltage supply at said fluid delivery device, said voltage supply powering said electronic pressure transducer.

17. The fluid delivery system according to claim 16, wherein said sensor includes said voltage supply.

18. The fluid delivery system according to claim 15, wherein said transmitter comprises an RF transmitter, said controller including an RF receiver for receiving said signal from said RF transmitter.

19. The fluid delivery system according to claim 11, wherein said fluid delivery device comprises a first fluid delivery device, further comprising a second fluid delivery device and a second pressure sensor sensing fluid pressure at said second fluid delivery device, said second pressure sensor generating a second pressure signal and being in communication with said controller, and said controller adjusting the delivery of fire fighting fluid to said second fluid delivery device based on said second pressure signal.

20. The fluid delivery system according to claim 19, wherein said second pressure sensor senses fluid pressure at an input of said second fluid delivery device.

21. A fire truck fluid delivery system comprising:
a fluid delivery device for delivering fluid;
a sensor, said sensor sensing a parameter of the fluid at said fluid delivery device and generating a parameter signal;
a wireless transmitter in communication with said sensor, and said transmitter transmitting said parameter signal; and
a control panel, said control panel including a gauge and a receiver, said receiver receiving said parameter signal from said transmitter and being in communication with said gauge, and said gauge displaying a parameter reading based on said parameter signal.

22. The fire truck fluid delivery system according to claim 21, wherein said fluid delivery device comprises a nozzle, a monitor, or a truck outlet.

23. The fire truck fluid delivery system according to claim 21, wherein said sensor comprises a pressure sensor, a flow sensor, an RPM sensor, or a temperature sensor.

24. The fire truck fluid delivery system according to claim 23, wherein said sensor comprises a pressure sensor.

25. The fire truck fluid delivery system according to claim 24, wherein said sensor comprises an electronic pressure transducer.

26. The fire truck fluid delivery system according to claim 25, further comprising a voltage supply, said voltage supply powering said electronic pressure transducer.

27. The fire truck fluid delivery system according to claim 21, wherein said transmitter comprises an RF transmitter.

28. The fire truck fluid delivery system according to claim 20, wherein said fluid delivery device comprises a first fluid delivery device, further comprising a second fluid delivery device and a second sensor, said second sensor sensing a parameter of the fluid at said second fluid delivery device and generating a parameter signal, and said control panel having a second gauge, said second gauge displaying said parameter of the fluid at said second fluid delivery device in response to said parameter signal.

29. The fire truck fluid delivery system according to claim 28, wherein said second sensor senses fluid pressure at said second fluid delivery device.

30. The fire truck fluid delivery system according to claim 22, wherein said sensor comprises a pressure sensor, said system further including a second sensor at said fluid delivery device, said second sensor selected from a flow sensor, an RPM sensor, and a temperature sensor, said second sensor in communication with said control panel, said control panel displaying information relating to one of flow rate, RPM, and temperature of the fluid at said fluid delivery device based in said second sensor.
